(19) United States
(12) Patent Application Publication
(10) Pub. No.: US 2008/0298249 A1
(43) Pub. Date: Dec. 4, 2008

(54) METHOD FOR SELECTION OF AN ASSOCIATION ACCESS POINT FOR A STATION IN A MESH NETWORK

(75) Inventors: Michael H. Baker, Elmhurst, IL (US); Ye Chen, Elk Grove Village, IL (US); Stephen P. Emeott, Rolling Meadows, IL (US); Isam R. Makhlouf, Lake Zurich, IL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/770,796

(22) Filed: Jun. 29, 2007

Related U.S. Application Data
(63) Continuation-in-part of application No. 11/754,684, filed on May 29, 2007.

(51) Int. Cl. H04L 12/28

(52) U.S. Cl. 370/238

(57) ABSTRACT

A method for selection of the association access point for a station in an infrastructure mesh network based on received signal strength and one or more “association bias” weights received from neighboring access points. Each weight corresponds to a packet length category. In one embodiment, stations measure received signal strength for received signals and decode the association bias information field(s) and corresponding packet length category thresholds that are received in management frames such as beacons. Stations use this information to select an access point for association that will minimize the overall mesh resource utilization for the traffic (i.e. packet lengths) being transmitted. The method includes three elements: network assistance, access point actions, and station actions.

### CROSS REFERENCES TO RELATED APPLICATIONS

This application is a continuation-in-part application of application Ser. No. 11/754,684, filed on May. 29, 2007, having Attorney Docket No. CML05061AHN, and which is incorporated herein by reference in its entirety.

### FIELD OF THE INVENTION

The present invention relates generally to communication networks and in particular to a method for a station to select an access point for which to associate in a mesh communication network.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network.

A wireless mesh network is a collection of wireless nodes or devices organized in a decentralized manner to provide range extension by allowing nodes to be reached across multiple hops. In a multi-hop network, communication packets sent by a source node can be relayed through one or more intermediary nodes before reaching a destination node. A large network can be realized using intelligent access points (IAP) which provide wireless nodes with access to a wired backhaul.

Wireless ad hoc networks can include both routable (meshed) nodes and non-routable (non-meshed) nodes. Meshed or “routable” nodes are devices which may follow a standard wireless protocol such as Institute of Electrical and Electronics Engineers (IEEE) 802.11s or 802.16j. These devices are responsible for forwarding packets to/from the proxy devices which are associated with them. Non-meshed or “non-routable” nodes are devices following a standard wireless protocol such as IEEE 802.11 a, b, e, g or IEEE 802.15 but not participating in any kind of routing. These devices are “proxied” by meshed devices which establish routes for them.

In a mesh network, routes between mesh nodes are set-up based on available mesh information including hop count to the destination, traffic load and link quality of each connection. Minimizing the hop count between a mesh node and its portal can, for example, reduce the amount of channel resources consumed forwarding traffic through a mesh and lower the overall congestion level on a channel.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an example communication network for operation in accordance with some embodiments of the invention.

FIG. 2 illustrates an example of the overheads for an 802.11abg voice frame exchange.

FIG. 3 illustrates a portion of the communication network of FIG. 1.

FIG. 4 is a chart illustrating network resource usage versus access rate of the network portion of FIG. 3.

FIGS. 5 and 6 illustrate various portions of the network 100 of FIG. 1 operating in accordance with various embodiments of the present invention.

FIG. 7 is a flowchart illustrating the operation of a station in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a selection of an association access point for a station in a mesh communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of method steps and apparatus components related to selection of an association access point for a station in a mesh communication network described herein. The non-processor circuits may include, but are not limited to, a radio receiver, a radio transmitter, signal drivers, clock circuits, power source circuits, and user input devices. As such, these functions may be interpreted as steps of a method for selection of an association access point for a station in a mesh communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

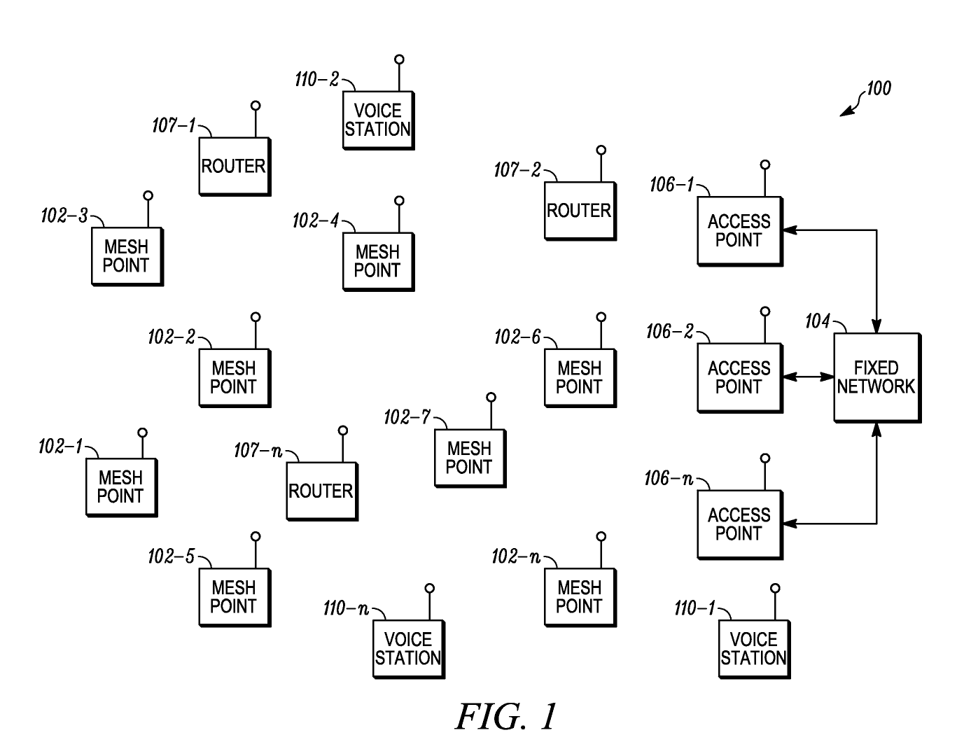

FIG. 1 is an example communication network for operation in accordance with some embodiments of the invention. Specifically, illustrates an ad hoc wireless communication network 100. The ad hoc wireless communication network 100, for example, can be a mesh enabled architecture (MEA) network or an 802.11 network (i.e. 802.11a, 802.11b, 802.11g, or 802.11s). It will be appreciated by those of ordinary skill in the art that the ad hoc wireless communication network 100 in accordance with the present invention can alternatively comprise any packetized communication network where packets are forwarded across multiple wireless hops. For example, the ad hoc wireless communication network 100 can be a network utilizing packet data protocols such as OFDMA (orthogonal frequency division multiple access), TDMA (time division multiple access), GPRS (General Packet Radio Service) and EGPRS (Enhanced GPRS). Additionally, each wireless hop of the packetized communication network 100 may either employ the same packet data protocol as the other hops, or a unique packet data protocol per hop.

As illustrated in FIG. 1, the ad hoc wireless communication network 100 includes a plurality of mesh points 102-1 through 102-n (referred to also as nodes 102 or mobile nodes 102 or communication devices 102), and can, but is not required to, include a fixed network 104 having a plurality of intelligent access points (IAP) 106-1, 106-2, . . . 106-n (referred to generally as nodes 106 or access points 106), for providing mesh points 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The ad hoc wireless communication network 100 further can include a plurality of fixed or mobile routers 107-1 through 107-n (referred to generally as routers 107 or nodes 107 or communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly or indirectly. When communicating indirectly, one or more other nodes 102, 106 or 107, can operate as a router or routers for forwarding or relaying packets being sent between nodes.

The ad hoc wireless communication network 100 further comprises one or more short packet stations, such as one or more voice stations 110-n as illustrated in FIG. 1. A short packet station typically communicates with packet lengths that are similar to the lengths of data and control packets for a voice-only station. For example, for a typical WLAN system a short packet station would have packet lengths less than about 256 bytes. It will be appreciated by those of ordinary skill in the art that the short packet stations (such as the voice stations 110-n) that associate with the mesh access points 106-n are generally not mesh-aware and typically do not have access mesh networking information which can help improve network performance. Therefore, the short packet stations (such as the voice stations 110-n) are susceptible to making suboptimal (re)association decisions and not making efficient use of network resources.

In one embodiment, the ad hoc wireless communication network 100 further comprises one or more other stations (that are not necessarily short packet stations) which are also not mesh-aware and also do not have access to mesh networking information which can help improve network performance. Therefore, these other packet stations also can be susceptible to making suboptimal (re)association decisions and not making efficient use of network resources.

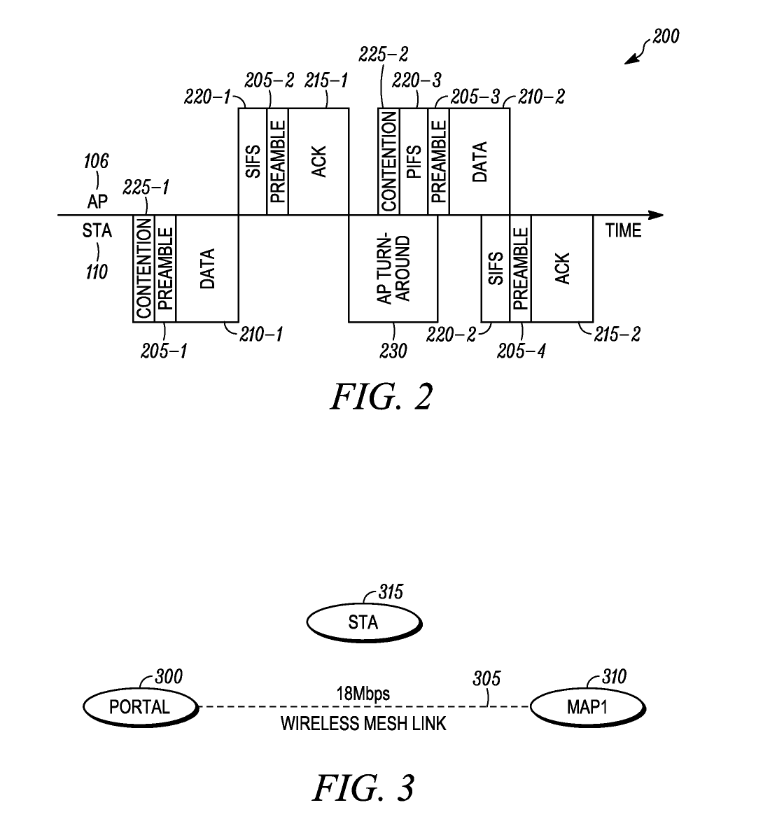

As an illustration, consider voice traffic for 802. 11. FIG. 2 illustrates an example of the overheads for an 802.11abg voice frame exchange 200. (For example, as specified in: American National Standards Institute/Institute of Electrical and Electronics Engineers (ANSI/IEEE) Standard 802.11: Wireless local area network (LAN) Medium Access Control (MAC) and Physical Layer (PHY) Specifications, 1999; ANSI/IEEE Standard 802.11a: “Wireless LAN Medium Access Control (MAC) and Physical Layer (PHY) Specifications; High-speed Physical Layer in the 5 Giga Hertz (GHz) Band,” 1999; ANSI/IEEE Standard 802.11b: “Wireless LAN Medium Access Control (MAC) and Physical Layer (PHY) Specifications; High-speed Physical Layer extension in the 2.4 GHz Band,” 1999; and ANSI/IEEE Standard 802.11g: “Part 11: Wireless LAN Medium Access Control (MAC) and Physical Layer (PHY) Specifications; Amendment 4: Further Higher Data Rate Extension in the 2.4 GHz Band,” 2003).

An 802.11 frame exchange between a voice station 110 and an access point 106 carries a number of required overheads that are not a function of the data link rate. These overheads include a preamble 205-n to the DATA 210-n and acknowledge (ACK) frames 215-n that must be transmitted at the lowest basic rate (6 Mbps (Mega bits per second) for 802.11ag) as well as interframe spacing periods 220-n including one or more short interframe spacing periods (SIFS) 220-1 and 220-2 and one or more Point (coordination function) interframe spaces (PIFS) 220-3, and time for contention for the media 225-n. AP turnaround time 230 is the amount of time that an AP device needs to retrieve the corresponding data frame for a given station after receiving an uplink data frame from that station. For short packets, the time to transmit the overhead can occupy significantly more time than transmission of the data payload. For example, for 802.11ag, a voice packet with a data payload at 54 Mega bits per second (Mbps) has a total duration of 0.274 milliseconds (ms) of which 0.185 ms is due to overhead.

FIG. 3 illustrates a wireless local area network (WLAN) portal 300 with an 18 Mbps wireless connection 305 to a mesh access point (MAPI) 310 to extend communication range. A station 315 located between the two devices (the wireless local area network (WLAN) portal 300 and the mesh AP (MAP1) 310) must choose either the portal 300 or the mesh access point (AP) 310 for association.

If the station 315 connects directly to the portal 300, then only a single wireless hop is needed. However, if the station (STA) 315 connects to the mesh access point (MAP1) 310, then two wireless hops are needed. An access hop is used to move traffic between STA 315 and MAP1 310 and a mesh hop backhauls the traffic between the portal 300 and MAP1 310. For 802.11a, the STA 315 has a number of rates that can be used for the access link to MAP1 310.

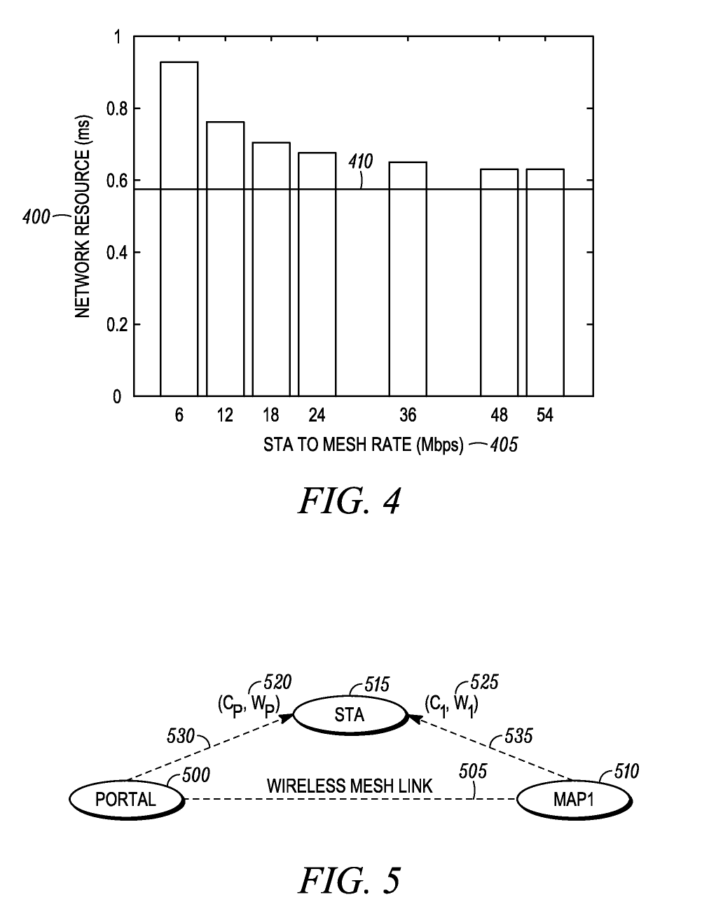

FIG. 4 illustrates the network resource usage 400 versus access rate 405 when the station 315 associates with the mesh access point 310. FIG. 4 also illustrates the worst case (highest) network resource (line 410) used for a direct connection to the portal 300. This worst case occurs when the direct portal connection is at the lowest rate (6 Mega bits per second (Mbps)). It will be appreciated by those of ordinary skill in the art that the worst case direct connection to the portal 300 uses fewer resources than any of the possible connections through the MAP1 device 310. With high overhead ratios for short packets, stations that make association decisions based strictly on received signal strength (RSS) can waste network resources.

The present invention provides a method for selection of the association access point (AP) for a station in an infrastructure mesh network based on received signal strength (RSS), a “congestion ration” (C) value, and one or more “association bias” weights (W₁-W_{N}) received from each neighboring access point (AP). Congestion ratio is a number between zero and one, with values near zero indicating low congestion and values approaching one indicating high congestion. Each weight corresponds to a packet length category. In one embodiment, stations measure RSS for received signals and decode the congestion ration (C) and association bias information field(s) (W₁-W_{N}) and corresponding packet length category thresholds (T₁-T_{N-1}) that are received in management frames such as beacons. Stations use this information to select an access point for association that will minimize the overall mesh resource utilization for the traffic (i.e. packet lengths) being transmitted. The method includes three elements: network assistance, access point (AP) actions, and station (STA) actions.

Network Assistance

In accordance with the present invention, network assistance is the mechanism used to provide the non-mesh enabled station (STA) with a congestion ratio and one or more weight values for each neighboring access point (AP). The current 802.11 standard describes passive scanning and active scanning techniques for transferring information between APs and STAs. The present invention provides for an information element field added to an existing management frame mechanism, such as to one or more beacons, to provide C, W₁-W_{N}, and corresponding packet length category thresholds, T₁-T_{N-1}, as shown in Table 1 below:

TABLE 1
Management Frame Information Element
New Management Frame Elements

| | | | | | | | | |
|---|---|---|---|---|---|---|---|---|
| Element ID (I) | C | W₁ | T₁ | W₂ | T₂ | . . . | T_{N-1} | W_{N} |

FIG. 5 illustrates a portion of the network 100 of FIG. 1 operating in accordance with one embodiment of the present invention. Specifically, FIG. 5 shows a portal 500 with a wireless mesh link to a mesh access point (MAP1) 510 to extend range. A station (STA) 515 located between the two devices (the portal 500 and the mesh AP (MAP1) 510) must choose either the portal 500 or the mesh access point (AP) 510 for association. In the embodiment of FIG. 5, beacons 530, 535 provide the STA 515 with Congestion Ratios and Weights (Cₚ, Wₚ 520 and C₁, W₁ 525). In this example, there is only a single weight, i.e. N=1. As illustrated in FIG. 5, the STA 515 listens passively for beacons 530,535 from neighborhood access points. The STA 515 hears beacons 530,535 from the portal 500 and the MAP1 510 and decodes the beacons 530,535 to get the congestion ratios and weight values (Cₚ, Wₚ 520 and C₁, W₁ 525).

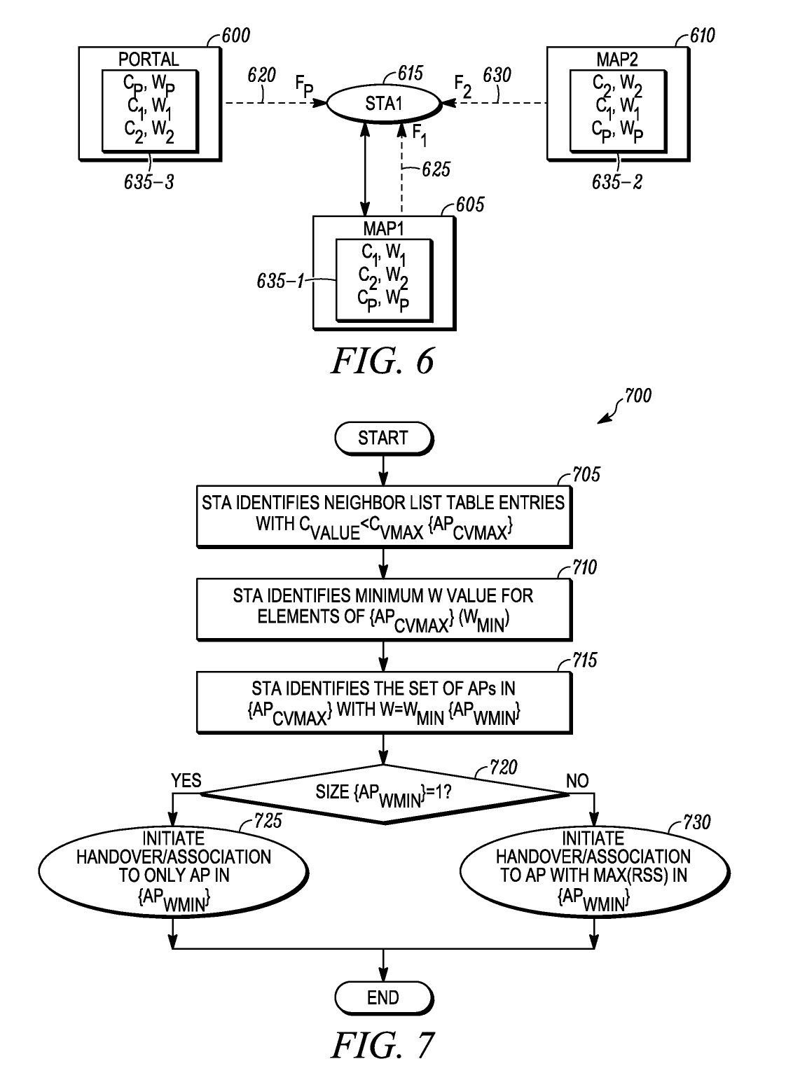

FIG. 6 illustrates a portion of the network 100 operating using an alternative embodiment of the present invention in which the STA 615 uses a combination of passive and active scanning to obtain the weight values. The new congestion and weight values are not located in beacons; instead they are shared among mesh enabled devices. (For example, the new congestion and weight values can be shared via mechanisms such as neighbor request reports as described in IEEE 802.11s “Draft Amendment to Standard for Information Technology—Telecommunications and Information Exchange Between Systems—LAN/MAN Specific Requirements—Part 11: Wireless Medium Access Control (MAC) and physical layer (PHY) specifications: Amendment: ESS Mesh Networking,” D1.00, November 2006; and IEEE 802.11k “Draft Standard for Information Technology—Telecommunications and information exchange between systems—Local and metropolitan area networks—Specific requirements, Part 11: Wireless LAN Medium Access Control (MAC) and Physical Layer (PHY) specifications,” D7.0, January 2007. Each AP builds a table 635-n containing a list of AP identification numbers versus congestion and weight based on the beacons it receives from its neighbor APs. For example, as illustrated in FIG. 6, the MAP1 605 builds its table 635-1, the MAP2 610 builds its table 635-2, and the portal 600 builds its table 635-3. A STA 615 determines that it has entered an area with infrastructure mesh by observing the frequency information element found in received 802.11 beacons. This observation occurs because a STA 615 receives multiple beacons all on the same channel (frequency). In FIG. 6, the STA 615 receives beacons 620, 625, and 630 from the Portal 600, MAP1 605 and MAP2 610 respectively, all on the same frequency (Fₚ=F₁=F₂). The STA 615 concludes it has entered an infrastructure mesh area and requests information from the nearest neighbor asking for the mesh aware neighbor list of weights. For our example, MAP1 is closest to STA1, so STA1 requests the neighbor weight table from MAP1 (table 635-1).

Access Point (AP) Actions

Each access point (AP) performs calculations of the congestion ratio and weight value(s). The AP calculates the congestion ratio (C) and one or more “association bias” weight(s) (W₁-W_{N}) information element(s), each weight corresponding to a given packet length category, that provides an indication of the suitability of a given mesh routing device for handling additional associations of a given packet length profile. That is, each weight corresponds to a pre-defined packet length category. A lower level indicates an AP that is more suitable for association. The bias level(s) mainly weight(s) the number of hops (H) to the wired portal, but may also consider other factors such as route robustness.

Each AP device has access to the environmental information, such as illustrated in Table 2 below, as well as predefined packet length category thresholds, which are used to calculate W₁-W_{N}. Hop count is an integer indicating the number of mesh wireless hops to the portal. Portals have a hop count of zero. Congestion ratio is a number between zero and one, with values near zero indicating low congestion and values approaching one indicating high congestion. The congestion metric could be a function of a variety of parameters including media access delay and receiver clear channel assessment. As an option, MAP devices may share congestion values and estimate maximum congestion along a route to the portal using the 802.11s “Congestion Level” information element.

TABLE 2
AP Environmental Information for Calculation of W

| List Element | Symbol | Description | Ref |
|---|---|---|---|
| Hop Count | h | Hop count to portal | 802.11s |
| Congestion | C | Maximum receive busy ratio along | 802.11s |
| Ratio (0 to 1) | | route from mesh AP to portal | |

Each MAP calculates a weight “Wₚ” for each packet length category based on hop cost,

Wₚ=Hₚ

Hop cost is a scaled version of hop count, where the scaling factor is a number between zero and one that is a function of the packet length category and mesh link rate category. The scaling factor tends towards zero for longer packet lengths and higher mesh link rates, and towards one for shorter packet lengths and lower mesh link rates. The following is an example formulaic definition of hop cost:

Hₚ=h*a/(R*Lₚ)

where

“a” is a normalization constant

“R” is proportional to the mesh rate(s) between the AP and portal

“Lₚ” is proportional to packet length category “p”,

“p” ranges from 1 to N

“N” is the number of packet length categories defined by the AP

The following tables demonstrate how R and Lₚ could be defined:

TABLE 3
Example definition of parameters “R”

| Mesh Rate < 24 Mbps | Mesh Rate > 24 Mbps |
|---|---|
| R = 1 | R = 2 |

TABLE 4
Example definition of parameters “Lₚ”

| Packet Length < 512 bytes | Packet Length >= 512 bytes |
|---|---|
| L₁ = 0.1 | L₂ = 1.0 |

In this case, N=2, and T₁=512.

Station (STA) Actions

The stations (STAs) take a number of actions in accordance with the various embodiments of the present invention. For example, each station uses passive (or active) scanning to obtain a congestion ratio (C) and one or more weight values (Wₚ) from each AP and measures signal RSS values. A single weight, W, is selected for each AP from the set of {W₁-W_{N}} based on the type of traffic the STA is transmitting. The STA expands the existing AP neighbor table to include C and W along with the RSS entry. STAs make initial association decisions based on RSS, W and C table entries and consider re-association based on changes in the RSS, W and C entries over time. Additional information on each of the above steps will be discussed hereinafter.

Legacy stations (for example, legacy 802.11 voice stations) listen for management frames (for example: beacon signals), make measurements of RSS on signals (i.e. beacons) received, and create a table of RSS versus AP identification number. In accordance with the present invention, the STA decodes the received signals to get the weight value (W) and add W as an entry for the STA neighbor table. Table 3 shows an example table entry in accordance with the various embodiments of the present invention. The neighbor table comprises an AP identification number, a measured RSS level and a weight (W) as shown below.

TABLE 5
Table Entry for Station Neighbor List

| | | | Network | Network |
|---|---|---|---|---|
| List | | Beacon | Assisted | Assisted |
| Element | AP ID | RSS | Congestion Ratio | Weight |
| Parameter | APᵢ | RSSᵢ | Cᵢ | Wᵢ |

The flowchart in FIG. 7 illustrates the flow decisions for station (STA) association 700 in accordance with embodiments of the present invention. As illustrated. The station association 700 operation begins with Step 705 in which the station identifies a subset of access points {AP_{CVmax}} from the neighbor list table of entries with C values less than Cᵥₘₐₓ. Next, in Step 710, the station identifies the minimum W value (Wₘᵢₙ) for elements of the subset of access points {AP_{CVmax}}. Next, in Step 715, the station identifies the set of APs in {AP_{CVmax}} with W=Wₘᵢₙ {AP_{wmin}}. Next, in Step 720, the station determines if more than one access point have W=Wₘᵢₙ. If only one access point has W=Wₘᵢₙ in Step 720, the operation continues to Step 725 in which the station initiates handover/association to the access point with the W=Wₘᵢₙ and the operation ends. If more than one access point has W=Wₘᵢₙ in Step 720, the operation continues to Step 730 in which the station initiates handover/association with the access point with the maximum RSS among the group of access points with W=Wₘᵢₙ and then the operation ends.

In other words, the station associates with the access point with the lowest weight whose congestion does not exceed the maximum congestion allowed (Cᵥₘₐₓ). This maximum congestion is a local value hard-coded into each of the stations. When the station is a voice station, it will be appreciated by those of ordinary skill in the art that voice stations are much more sensitive to congestion level than best effort data devices. In order to maintain a voice call, congestion must be below Cᵥₘₐₓ. If two or more APs have the same weight value, then association is done based on best RSS.

Once a STA has associated with an AP, it continues monitoring received signals (such as received beacons), measuring RSS, decoding weight values and updating the STA neighbor list table. If significant changes occur in the Weight value or RSS value, the association flow shown in FIG. 7 is triggered once again. In one embodiment, if a STA is associated with APx, triggers for execution of the association flowchart are:
Wᵢ<W_{X}−ΔW for any i, where ΔW is a constant (0.2<ΔW<1)
RSSᵢ>RSS_{X}+ΔRSS for any i where ΔRSS is a constant (2 dB<ΔRSS<10 dB)

In an alternate embodiment, if a STA carries mixed voice and data traffic an estimation of the predominant type of traffic between the station and AP could be made by the station. If the traffic is determined to be predominantly short packet (voice) then the device could be treated as a voice STA and the operation of the present invention could be used for association and handover decisions.

As described herein, the present invention, provides for network assistance which allows non-mesh enabled short packet STAs to make better association decisions than the prior art based RSS based algorithms. The STA does not need all the mesh-aware routing information available to mesh access points. Only a single weight value is needed. Further, routes that have any access point with congestion above the maximum allowed for the short packet devices are excluded from consideration for association. The congestion ratio may be based on the “Congestion Level” information element such as in the 802.11s specification proposal referenced previously herein or a combination of this element along with other congestion parameters available to AP devices including the media access delay and receive busy time as measured by the clear channel assessment hardware.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for selection of an association access point for a station in a mesh network, the method comprising:
at the station:
receiving a received signal strength and one or more association bias weights from each of one or more neighboring access points; and
selecting the association access point by using the received signal strengths and one or more association bias weights to determine which of the one or more neighboring access points will minimize a network resource utilization for a traffic transmission.

2. The method as claimed in claim 1, wherein the station comprises a short packet station.

3. The method as claimed in claim 2, wherein the short packet station comprises a voice station.

4. The method as claimed in claim 1, wherein each association bias weight corresponds to a packet length category.

5. The method as claimed in claim 1, further comprising:
sending a message from each of the one or more neighboring access points, the message including a management frame information element comprising:
the one or more association bias weights, and
one or more corresponding packet length category thresholds.

6. The method as claimed in claim 1, further comprising:
at the station:
passively listening for one or more messages;
receiving a message from each of the one or more neighboring access points; and
decoding the message to obtain each of the association bias weights.

7. The method as claimed in claim 6, wherein the message comprises a beacon.

8. The method as claimed in claim 6, wherein the message comprises a management frame information element.

9. The method as claimed in claim 1, further comprising:
at each access point:
storing a table comprising a list of access point identifications and associated bias weights; and
at the station:
receiving a message from each of the one or more neighboring access points;
determining that each of a plurality of received messages was received on the same frequency channel; and
requesting the association bias weight information from a nearest neighbor access point.

10. The method as claimed in claim 9, wherein each of the messages comprises a beacon.

11. The method as claimed in claim 9, wherein each of the messages comprises a management frame information element.

12. The method as claimed in claim 1, further comprising:
at each of one or more neighboring access points:
calculating one or more association bias weights corresponding to predefined packet length categories including one or more factors selected from a group of factors comprising a number of hops to an infrastructure portal, a media congestion, and a route robustness.

13. The method as claimed in claim 1, further comprising:
at the station:
storing a table including entries for each of the one or more neighboring access points, associated received signal strength, associated bias weights, and associated congestion parameters; and
selecting the association access point using the stored table entries.

14. A method of operation of a station for selection of an association access point for the station in a mesh network, the method comprising:
storing a neighbor list table comprising a plurality of access points, associated congestion value, associated weight, and associated received signal strength;
identifying a subset of the access points from the neighbor list table with congestion values less than a predetermined maximum congestion value;
determining which of the subset of the access points has the lowest weight; and
associating with the access point having the lowest weight whose congestion value is less than the predetermined maximum congestion value.

15. A method as claimed in claim 14, further comprising:
when more than one access point of the subset have the lowest weight, identifying and associating with the access point with the lowest weight that has the maximum received signal strength.

16. A method as claimed in claim 14, further comprising:
monitoring received signals and updating the neighbor list table; and
repeating the identifying, determining, and associating steps when a change is detected.
